(19) United States
(12) Patent Application Publication
(10) Pub. No.: US 2022/0117243 A1
(43) Pub. Date: Apr. 21, 2022

(54) SUPER-THIN TIN BREAD, METHOD OF ITS PRODUCTION AND ITS USE

(71) Applicant: Zinovi Brusilovski, Kiryat Gat (IL)

(72) Inventor: Zinovi Brusilovski, Kiryat Gat (IL)

(21) Appl. No.: 17/485,359

(22) Filed: Sep. 25, 2021

Related U.S. Application Data
(63) Continuation-in-part of application No. 17/076,210, filed on Oct. 21, 2020, now abandoned.

(51) Int. Cl. A21D 13/40; A21B 3/13; A21D 8/06

(52) U.S. Cl. CPC A21D 13/40; A21D 8/06; A21B 3/133

(57) ABSTRACT

The method of baking bread disclosed herein provides a new super-thin tin bread, technology, and equipment for baking the super-thin bread. The thickness of such bread is roughly equal the thickness of pieces of bread cut off from a loaf of bread. Pieces of such bread have the same crust on all sides except one, and do not crumble. It is simple and quick to cook. Sandwiches prepared from the thin bread contain a minimum amount of bread. Super-thin bread bakes several times faster than a regular loaf of the same weight. This translates into sizeable savings as less electricity, fuel, and labor will be required. Cooling, freezing, defrosting and baking of super-thin bread to perfection will also become faster and more efficient. Super-thin bread can be quickly baked at home in specialized toasters and in mini-bakeries, in automatic lines.

### CROSS-REFERENCE TO RELATED APPLICATIONS

This application is a continuation-in-part of U.S. patent application Ser. No. 17/076,210, filed on Oct. 21, 2020, now pending. The content of the above-referenced application is incorporated by reference in its entirety for all purposes.

### TECHNICAL FIELD

The present disclosure relates to the production of baked goods and, in particular, to the methods of production and use of super-thin forms of bread.

### BACKGROUND

Bread manufacture is a process of preparing the dough by mixing several ingredients. The ingredients could be flour, water, and yeasts. Proofing the dough and baking the dough. In some cases, fillers improving bread taste, shelf time, and other bread properties could be added to the mix.

There are several basic bread manufacturing technologies. The term bread or hearth bread defines a baking method in which the baking of fermented dough takes place on the floor of the oven; flatbread is bread made from thoroughly rolled and flattened dough. Typically, flatbread is unleavened. A tin bread, also called pan bread, is baked in a container or form and takes the shape of the container. Form bread, also called sweet bread, is baked in a container or form and takes the shape of the container.

All types of bread are prepared and proofed on a horizontal surface. The baking of the bread also takes place on horizontal surfaces. United States patents and patent applications 2017/0181575A1, 20180184670A1, 2010/0215801A1, U.S. Pat. No. 6,013,300A, and European patent EP1911384B1 describe such baking processes. These baking processes do not provide identical top and bottom crusts on bread products. Baking in a closed volume as disclosed in United States patents and patent applications 2017/0181575A1, U.S. Pat. Nos. 6,013,300, and 5,897,900 also does not provide the same crust on top and bottom of the bread or bread products.

Flat breads like pita bread, tortillas, and ciabatta are relatively thin and do not require baking forms or molds. The texture on both sides of such slice of bread is not identical. Thin super bread can also be a piece of bread, sliced from a loaf. The texture on both sides of such slice of bread is identical and without crusts (consists only of crumb). But cutting such bread into a flat and thin enough slices 2-5 mm thick is almost impossible. Even if it were possible to cut such bread to such a thickness, then such thin pieces would bend under their own weight and would not withstand any filling. Typically slices of bread are ½″ thick (about 12-13 mm). Minimum thickness is ¼″ (about 6 mm). Maximum−1 inch (approximately 25 mm). One slice of bread, depending on the bread, have between 100 and 200 calories in it.

Baking of molded bread and baking bread, in general, is a rather long and energy-intensive process. The dough has a significant mass that needs to be brought to the desired temperature. When baking bread, the dough is heated gradually—from the dough surface to the center. Therefore, all the processes related to bread baking do not proceed at the same time.

The surface of the dough heats up quite quickly. But the warm-up time of the central part of the dough depends on the distance to the surface. The larger the bread size, the longer it takes to warm up and bake the central part of the bread. Reducing the thickness of bread in the production of the bread would lead to a reduction in the time of bread manufacture and reduce the energy costs.

Existing sandwiches are quite thick, and it is not always convenient to eat them. In many cases, you need to open your mouth wide to bite off a piece. The filling can fall out of the sandwich, stain the face, hands, clothes. Sandwiches include a relatively large percentage of bread, which can not be reduced, because thin slices of bread will bend and will not hold the filling. A large amount of bread in a sandwich makes such a product a high-calorie product.

When baking regular bread, fresh herbs, like additives, are not used. The herbs do not withstand prolonged heating and lose many of their properties.

In open-top molds, yeast bread is baked, the width and height of such bread are roughly the same. The surface area of the top of the loaf roughly corresponds to the area of its side surface. Thin flat bread is not baked in forms.

Small dough blanks are baked in closed forms. Such products do not have the texture of bread neither in the outer crusts, nor inside of the dough blanks. One of the reasons for this is that baking yeast bread in closed forms leads to the fact that during baking the dough completely fills a limited space of the form and is in a compressed state.

There are many types of stuffed bread or bread with fillings. Three basic technologies are used to make such bread. The first—the middle of the baked bread is removed, and a filling fills the empty space. Following this, the bread is baked. The second method—the filling is wrapped in rolled dough, after which there is baking. The third—the filling is filled with liquid dough, and the bread is baked.

Bread is baked in bakeries, ovens, ovens for Baking Bread Cookies, on conveyors. Currently, toasters are not used for baking bread.

No matter how much we would like to minimize the amount of bread products in our sandwiches, it is not feasible, so because bread is not just part of the sandwich, it is also the “packaging” for the sandwich's filling. Currently the minimum thickness of soft slices of bread in sandwiches is limited by the need to keep the filling from falling out.

Thinner slices in sandwiches will bend in human hands, crumble and will not hold the filling. Therefore, now the minimum thickness of soft bread slices in sandwiches (6-8 mm) is limited by the need to keep the filling from falling out.

Super-thin bread with two identical crusts on both wide sides is disclosed herein and solves some of the discussed problems.

### SUMMARY

Disclosed herein is a method and apparatus for baking a super-thin bread baked in molds. The baking devices support the manufacture of super-thin bread such that the thickness of the baked bread is roughly equal or smaller (3-20 mm) than the thickness of bread slices cut off from a loaf of bread.

Disclosed herein is a method for baking a super-thin tin bread, the super-thin bread having a thickness of 5-50 mm, a length from 50 to 400 mm and a width from 50 to 400 mm, the method comprising: providing a dough in a baking mold having a thickness of 5-50 mm, a length from 50 to 400 mm and a width from 50 to 400 mm, in such a way that only one, narrow side of the dough in the baking mold faces air and the other five sides face a surface of the baking mold;
placing the baking mold with the dough into an oven in an upright position so that the narrow air-facing side of the dough is directed upwards;

baking the super-thin tin bread in the oven, wherein during baking an essentially identical crust is formed on all sides of the super-thin tin bread, except for the narrow air-facing side

placing the baking mold with the dough into an oven in an upright position so that the narrow side of the dough is directed upward and is air-facing; baking the super-thin tin bread in the oven, wherein during baking an essentially identical crust is formed on all sides of the super-thin tin bread, except for the narrow air-facing side.

The super-thin tin bread baked according to this method will have approximately a form of a rectangular prism, having four narrow sides and two wide sides. Deviations in the form of the bread are possible due uneven distribution of the dough in the baking mold, creating curved edges and/or surfaces of the bread.

When the baking mold is placed into the oven in the upright position, two wide sides and two narrow sides of the baking mold are vertical, and the other narrow side of the baking mold is horizontal. The horizontal side of the baking mold is a bottom side (or edge) of the baking mold. The opposite side from the bottom is an opening.

In some embodiments, the baking mold is a part of automatic baking lines.

In some embodiments, the super-thin tin bread is baked in the oven from the dough having a mass of 0.5 kg in less than 15 min.

In some embodiments, providing the dough in the baking mold comprises placing the dough in a middle section of the baking mold such that during placement the dough is not in contact with a bottom side of the baking mold, which is a lowest side of the baking mold when the baking mold is placed into the oven in the upright position.

In some embodiments, during placement the dough is placed at a distance of least 30 mm from the bottom side of the baking mold. In some embodiments, during placement the dough is placed at a distance of about 30 mm, 40 mm, 50 mm from the bottom side (edge) of the baking mold.

The term “essentially identical crust” as used herein refers to an essentially identical crust formed on five sides of the super-thin tin bread, and means that the crusts are baked in essentially identical conditions, so physical, chemical and gustatory parameters of the crusts differ no more than 15% from each other. These permissible deviations account for uneven heat flows in the existing ovens. If baking conditions allow for a tigher control, permissible deviations can be no more than 10% or no more than 5%.

Disclosed herein is also a super-thin tin bread obtained by the method disclosed above. In some embodiments, such super-thin bread has a thickness of 5-20 mm. In some other embodiments, such super-thin bread has a thickness of 3-10 mm, 3-5 mm, 5-10 mm or about 5 mm. In some embodiments, the upper or lower crust of such such super-thin bread has 1-2 mm wide depressions so that the filling can be put in the cut pieces into this depression, and the protrusions along the perimeter of these cut pieces 2-5 mm wide will prevent falling out of the filling from the sandwich. In some embodiments, the baking mold has protrusions such that crust of wide sides of the super-thin bread has 1-2 mm depressions suitable for putting a filling inside the super-thin bread.

Disclosed herein is also a super-thin tin bread having essentially a rectangular prism form with a thickness of 5-50 mm, a length from 50 to 400 mm and a width from 50 to 400 mm, wherein the super-thin tin bread has an essentially identical crust formed on five sides of the super-thin tin bread, and has a different crust formed on one of the narrow sides.

In some embodiments, such super-thin bread has a thickness of 5-20 mm. In some other embodiments, such super-thin bread has a thickness of 3-10 mm, 3-5 mm, 5-10 mm or about 5 mm. In some embodiments, the upper or lower crust of such such super-thin bread has 1-2 mm depressions so that the filling can be put in the cut pieces into this depression, and the protrusions along the perimeter of these cut pieces 2-5 mm wide will prevent falling out of the filling from the sandwich. In some embodiments, the super-thin tin bread has 1-2 mm wide depressions on crust of wide sides of the super-thin bread suitable for putting a filling inside the super-thin bread.

Super-thin bread disclosed herein has some advantages compared to existing bread products. Due to its reduced thickness and identical crusts on wide sides, it is a “stronger” product, such that it will not bend or crumble when used in sandwiches. It is thinner than existing bread slices. At the same time, sandwiches do not change their shape in the hands of a person. As a result, sandwiches with such bread have less amount of bread.

Super-thin bread can be baked in a variety of environments, such as residential or home environments, restaurants, cafes, shops, and industrial bakeries. Described are also different devices suitable for use in these environments.

The size of the molds for baking the super-thin bread corresponds to the sizes of portions of food prepared in toasters. The size of the molds supports the use of baking toasters for baking the super-thin bread in different environments. Large bakeries for baking can use conveyors.

The molds include markings indicating a desired location of the dough. The dough for baking is laid on the marked part of the mold when the mold is in a horizontal position. The mold is then closed and placed in a vertical or upright position—for the proofing and for baking. When baking on a conveyor belt, a continuous ribbon of moving dough passes the rack and baking takes place in an upright position.

Super-thin bread disclosed herein has a soft spongy structure inside and crusts on both wide sides with essentially the same properties—texture, color, thickness, taste, hardness, crunch. The bread could be baked to include different fillings or staffings. The fillings could include herbs, vegetables, dried fruits, sausages, and cheese. Sandwiches prepared from the super-thin bread contain a minimum amount of bread and substantially fewer calories as compared to sandwiches made with bread pieces cut from a loaf

Pieces of super-thin bread baked in the form have a number of advantages compared to pieces of bread cut off from a loaf of the same size.

Sandwiches with super-thin bread can contain less amount of bread, and thus less calories.

### BRIEF DESCRIPTION OF THE DRAWINGS

Those of skill in the art will understand that the drawings, described below, are for illustrative purposes only. The drawings are not intended to limit the scope of the present teachings in any way. To understand better the apparatus and method and to see how it may be carried out in practice, non-limiting examples are alos described below with reference to the accompanying drawings, in which identical referral numbers refer to similar or identical parts.

FIG. 1A is an dough in a mold before baking a loaf of bread;

FIG. 1B is an dough in a mold before baking super-thin bread;

FIG. 2 is an comparison of the heating time of the surface of the dough and the central part of the dough during baking;

FIG. 3A is an example of a piece of a super-thin bread with crusts on all sides, baked in an upright standing mold;

FIG. 3B is an example of a piece of a super-thin bread cut off from baked in FIG. 17C larger size super-thin bread piece with crusts on two sides;

FIG. 3C is an example of a piece of super-thin bread with a crust on one side, obtained by cutting along the pieces of super-thin bread of FIG. 3A, FIG. 3B, FIG. 19;

FIG. 4A is an example of a piece of super-thin bread with crusts on all sides, having a ledge preventing from falling out of the filling of a super-thin bread;

FIG. 4B is a cross-section of a piece of super-thin bread of FIG. 4A;

FIG. 4C is an example of a tilted piece of super-thin bread with a ledge and filling;

FIGS. 5A and 5B are examples of two baked pieces of super-thin bread of different sizes with crusts on all sides, and marked cut lines;

FIGS. 5C and 5D are examples of two bread pockets of different sizes prepared from pieces of super-thin bread cut along marked cut lines illustrated in FIGS. 5A and 5B;

FIG. 6 is a three-dimensional illustration of a rack holding molds for baking super-thin bread in different types of ovens;

FIG. 7A is an example of a developed toaster adapted for baking the super-thin bread;

FIG. 7B is a side view of closed of a developed toaster adapted for baking the super-thin bread, in a working position;

FIG. 8 is an example of a pop-up toaster for baking super-thin bread;

FIG. 9A is a three-dimensional illustration of an assembly of a mold suitable for baking super-thin bread in different types of ovens;

FIG. 9B is an example showing two parts of the mold of FIG. 9A;

FIG. 10A is a schematic frontal and side cross-sections of the mold for baking super-thin bread, filled with dough before the proofing.

FIG. 10B is a schematic frontal and cross-section of the mold for baking super-thin bread filled with dough after the proofing;

FIG. 11A is a schematic frontal and cross-section view of the mold and the location of the dough in this mold, filled with dough before the proofing.

FIG. 11B is a schematic cross-section of the dough location in the mold after the proofing;

FIG. 12A is an example of a part of a mold for baking super-thin bread in baking toaster;

FIG. 12B is an example of a part of a mold for baking ready to eat pieces of bread of various sizes in a baking toaster;

FIG. 12C is an example of a part of a mold for baking slices of bread of having a ledge in a baking toaster;

FIG. 13A is a schematic cross-section of a closed mold in a baking toaster of FIG. 7A;

FIG. 13B is an additional schematic cross-section of a closed mold for baking pieces of bread having a ledge in a baking toaster;

FIG. 13C is an enlarged cross-section of the part of the mold that forms a ledge on pieces of super-thin bread;

FIG. 14 is an example of a rack into which molds could be inserted dough proofing and baking super-thin bread in ovens;

FIG. 15 is an illustration of a “cage” with a mold for insertion into a pop-up toaster for proofing and baking super-thin bread;

FIG. 16A is a simplified top view of an example of an automatic line for baking super-thin bread;

FIG. 16B is a simplified side view of an example of an automated line for baking super-thin bread;

FIG. 17A is a super-thin bread with a crust on all sides, baked in a baking toaster of FIG. 12B;

FIG. 17B is an illustration of a super-thin bread with crust on all sides, baked in the oven in a mold of FIG. 12A;

FIG. 17C is an illustration of large pieces of super-thin bread with crust on all sides, baked in a large size industrial oven;

FIG. 18A are pieces of cut super-thin bread 45 millimeters thick with crusts on both sides baked in a baking toaster of FIG. 7A;

FIG. 18B is a cut of a piece of super-thin bread 5 millimeters thick with crusts on both sides, baked in a baking toaster of FIG. 7A;

FIG. 18C is a piece of super-thin wheat bread with a crust;

FIG. 19 is a piece of super-thin bread with two crusts, divided along with the length of the piece with a knife;

FIG. 20 shows different textures and different color of super-thin bread crusts;

FIG. 21A is an example of a super-thin bread with two thick and dense crusts;

FIG. 21B is an example of a super-thin bread with two thin and soft crusts;

FIG. 22 is an example of a piece of super-thin elastic bread with two soft crusts that do not crumble;

FIG. 23 illustrates pieces of super-thin bread with two crusts, baked from different flours;

FIG. 24 is an illustration of a piece of super-thin bread with a ledge filled with filling and tilted at an angle of 60 degrees;

FIG. 25 is a cross-section of super-thin bread with pieces of sausages;

FIG. 26 is an illustration of an open sandwich with cheese, lettuce and a piece of super-thin bread with two crusts;

FIG. 27A, FIG. 27B, and FIG. 27C are additional illustrations of super-thin sandwiches;

FIG. 28 is a super-thin bread sandwich strong enough to support the filling;

FIG. 29 is a comparison of the amount of bread in a conventional sandwich and a super-thin bread sandwich;

FIG. 30A and FIG. 30B illustrate super-thin bread sandwiches where a part of the super-thin bread is divided into two pieces, and a part of the super-thin bread maintains its integrity;

FIG. 31A and FIG. 31B illustrates a super-thin bread pocket with different fillings.

FIG. 31C is a comparison of the amount of bread in sandwiches with a super-thin bread pocket and baguette with the same filling.

### DETAILED DESCRIPTION

Unless otherwise noted, technical terms are used according to conventional usage.

In the present disclosure, the term “tin bread” refers to a bread baked from a dough in baking molds of different forms and sizes, wherein the dough fills in the baking mold before baking, and the form of the resulting bread essentially copies the form of the baking mold. Typically, tin bread has essentially a form of a rectangular prism, with vertices of the rectangular prism being smoothed due to imperfect filling of the baking mold by the dough before and during the baking process.

Bread crust is formed on surface of the dough during baking process. A crust is formed when the dough comes into contact with hard surfaces, such as mold of form surfaces, horizontal surfaces; or a crust is formed when the dough comes into contact with air. The crust of bread is the part of dough that had the highest exposure to heat when baked. Bread crust gets hardened and browned through the Maillard reaction (between sugars and amino acids) due to the intense heat at the bread surface during baking process. Bread crust typically forms the outer surfaces of the baked bread product, wherein a softer internal portion of bread is called bread crumb, which is surrounded by the crust. The Maillard reaction provides bread crust with a different color, texture and flavor, compared to the rest of the bread product (bread crumb), which is softer by texture, and has less intense flavor compared to the crust. The temperature at which the crust is baked is typically around 180-200 degrees Celsius, whereas the temperature at which the crumb is baked is less than 100 degrees Celsius.

In the preferred embodiment, super-thin tin bread disclosed herein is baked from dough in a narrow, upright baking case, wherein only one, narrow side of the dough in the baking case faces air and the other sides face a surface of the baking case. Thus, during baking an essentially identical crust is formed from the dough on all sides of the super-thin tin bread, except for the narrow air-facing side, which has a different crust. Essentially identical crusts present on five sides of the super-thin tin bread (four sides and bottom) have essentially the same properties (appearance, physical-mechanical, quality, color, taste, aroma, texture) due to nearly identical conditions they face during baking, since they are in contact with the surface of the baking case.

In the preferred embodiment, super-thin tin bread disclosed herein has essentially a form of a rectangular prism having a thickness of 5-50 mm, a length from 50 to 400 mm and a width from 50 to 400 mm. In some embodiments, vertices of the rectangular prism are smoothed due to imperfect filling of the baking mold by dough before and during the baking process. In some embodiments, the form of super-thin tin bread disclosed herein may deviate from a rectangular prism, such as, for example, the upper or lower crust has 1-2 mm depressions so that the filling can be put in the cut pieces into this depression, and the protrusions along the perimeter of these cut pieces 2-5 mm wide will prevent falling out of the filling from the sandwich.

The current disclosure provides a super-thin tin bread, a device, and a way to bake the super-thin bread in a residential and industrial environment. Super-thin bread can be made at home, in restaurants, cafes, shops, in bakeries. Any yeast dough, sourdough, gluten-free dough, and other types of dough can be used to make pieces of super-thin bread.

Aspects of the present teachings may be further understood in light of the following examples presented below, which should not be construed as limiting the scope of the present teachings in any way. Below, exemplary methods and apparatus for baking a super-thin tin bread are disclosed.

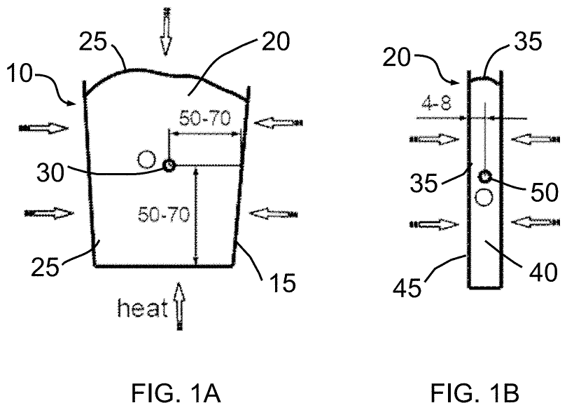

Now most of the time (20-40 min) is not spent on baking a loaf of bread, but on heating the dough in the center of the loaf (O) (FIG. 1A) to the temperature of turning the dough into bread. The reason is the low thermal conductivity of the dough and the large distance from the surface of the dough to the center O (50-70 mm).

In super-thin bread, the dough in the center (O) (FIG. 1B) heats up many times faster than when baking tin bread.

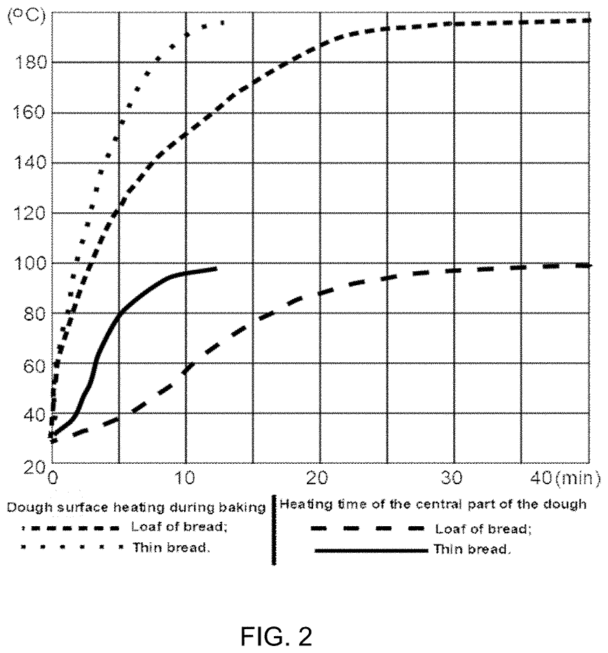

Comparison of the heating time of the dough surface and the central part of the dough during baking of pan bread and thin pan bread is shown in FIG. 2. In this example, the moisture content of whole grain flour dough is about 64%. The weight of the dough pieces is about 500 grams. The center of the bread dough piece is 50 mm from the edge of the mold. The heating time of the center of the dough depends on the thermal conductivity of the dough. The temperature in the oven is about 200 Celsius. For heating the center of the above dough until the moment the dough turns into bread, this time is about 15 minutes. Center of super-thin bread dough is 6 mm from the edge of the mold. The heating time of the center of the dough until the beginning of the transformation of the dough into bread is about 5 minutes. The total baking time for this super-thin bread is about 13 minutes. The total time to bake a regular loaf of bread is about 40 minutes. In this example, super-thin bread is baked three times faster than a loaf of bread of the same weight.

Difference in baking time of a regular loaf of bread weighing 1 kg and super-thin bread 10 mm thick and weighing 1 kg will increase six-fold. This difference in baking time for a loaf of bread and super-thin bread of the same weight depends on the ratio of the distances to the centers of the dough pieces. For a loaf of bread weighing 1 kg, this distance is about 70 mm, for super-thin bread—about 5 mm. When baking super-thin bread, many technological operations are significantly accelerated. A three to six times shorter baking time for super-thin bread leads to decrease in consumption of electricity, gas or diesel fuel in ovens when baking super-thin bread per unit weight, which is reduced three to six times on average. The cooling of super-thin bread after baking in refrigerators is also three to six times faster, and saves energy. Freezing super-thin bread after cooling also occurs three to six times faster, and saves energy. Bakeries and bakeries are major sources of greenhouse gas emissions into the air. The production of super-thin bread will reduce greenhouse gas emissions, including carbon monoxide (CO2), by three to six times.

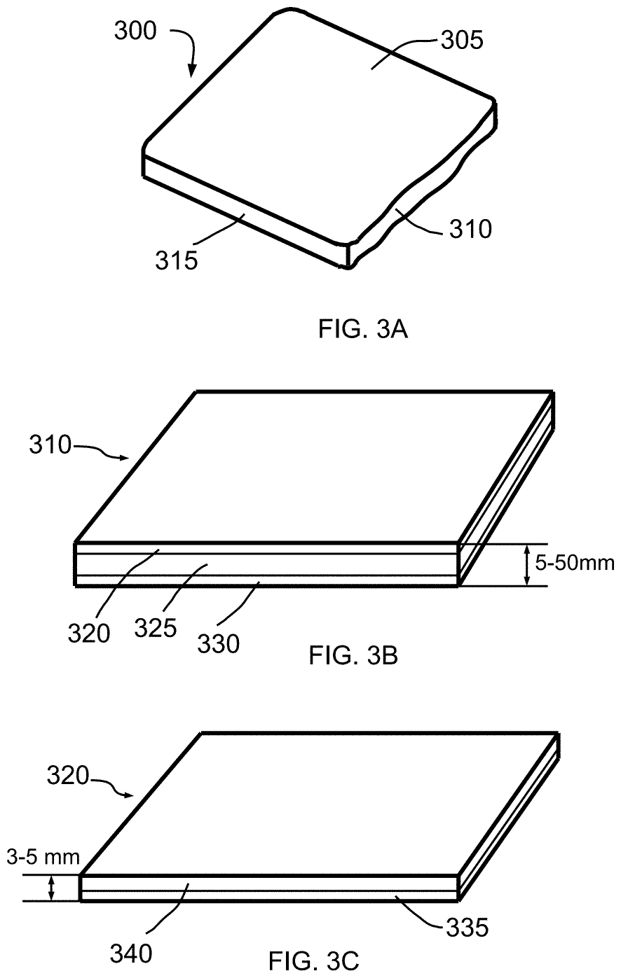

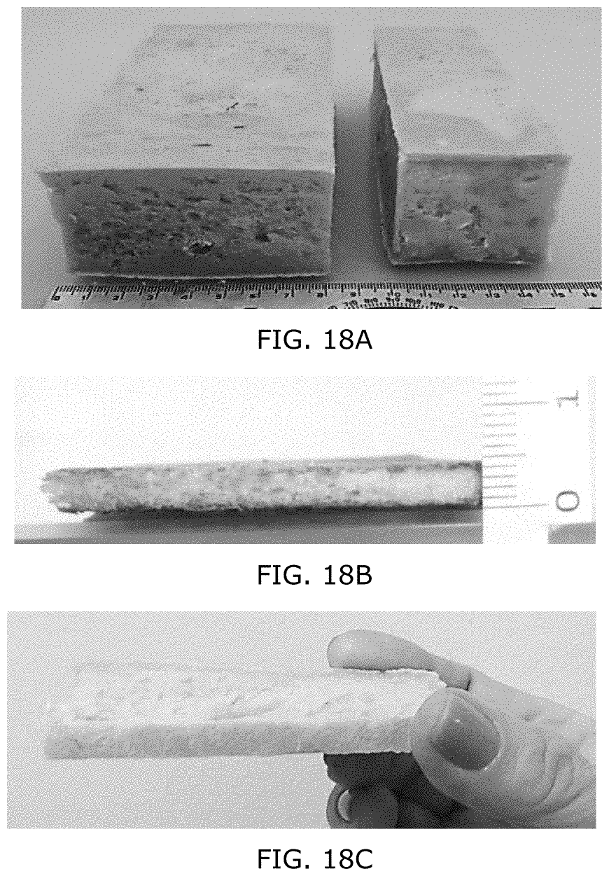

Super-thin bread 100 (FIG. 3A), 110 (FIG. 3B), 120 (FIG. 3C) has a thickness of 5 to 16 millimeters, which corresponds to the thickness of the bread slices cut from the loaf. But it can be baked to a thickness of about 50 millimeters (FIG. 18A). The length and width of super-thin bread depends on the size of the molds and can range from 50 to 400 millimeters. Super-thin bread has a soft spongy inner structure.

Pieces of super-thin bread 300 (FIG. 3A) can have crusts 305, 310, 315 on all sides, if they are baked with sizes corresponding to sizes for consumption. Crusts 320, 330 (FIG. 3B) of the pieces of super-thin bread 310 are essentially identical crusts.

In comparison, new thin slices of regular bread are cut from the inside of the soft part of the finished loaf, and the top and bottom sides of the slice are crustless. These soft slices are the same size as a loaf of bread.

In all existing bread products, regardless of composition of the dough, the top and bottom crusts differ from each other in color, texture, hardness, thickness, taste, aroma. The reason is that these crusts have different baking conditions. Such bread products typically have the top crust formed from the upper part of the dough when baking; the upper part of the dough comes into contact with the air, forming this type of crust. Also, such bread products typically have the bottom crust formed from the lower part of the dough during baking; the lower part of the dough comes into contact with a hard surface—metal, Teflon, stone, ceramics, etc. It has different baking conditions and forms a different type of crust.

Disclosed super-thin bread has essentially identical crust on all sides except on the narrow side (edge) of the bread, including essentially identical crust on the two wide sides of the bread (top and bottom), which are used for holding the bread while eating. This effect is obtained due to the fact that the top and bottom surfaces of the dough are in exactly the same conditions during baking, in contact with the baking mold. Both sides of the slices of super-thin bread, top and bottom, are baked in the same conditions, but the permissible deviation of their physical, chemical, gustatory parameters, aromas is possible due to uneven heat flows in the ovens. Such differences can be no more than 10-15%.

Located between the crusts is a relatively soft bread structure 325.

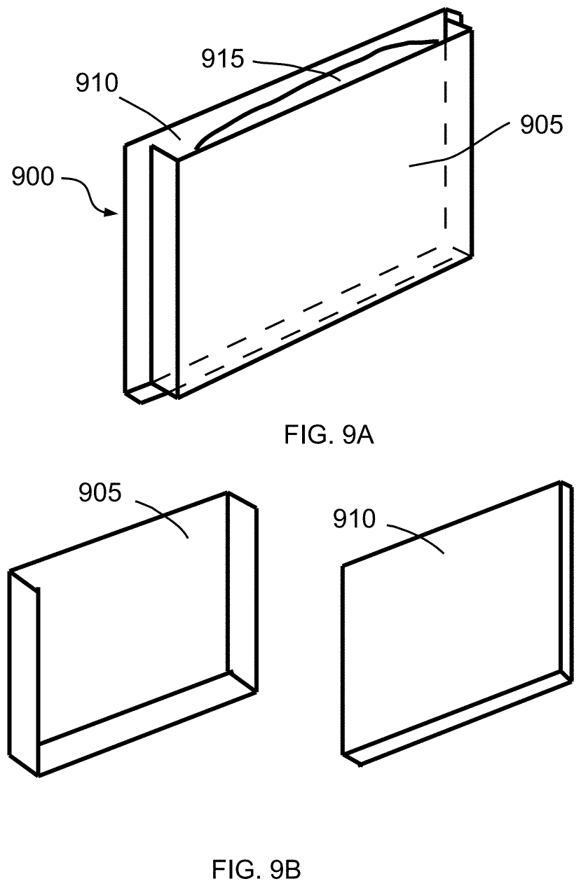

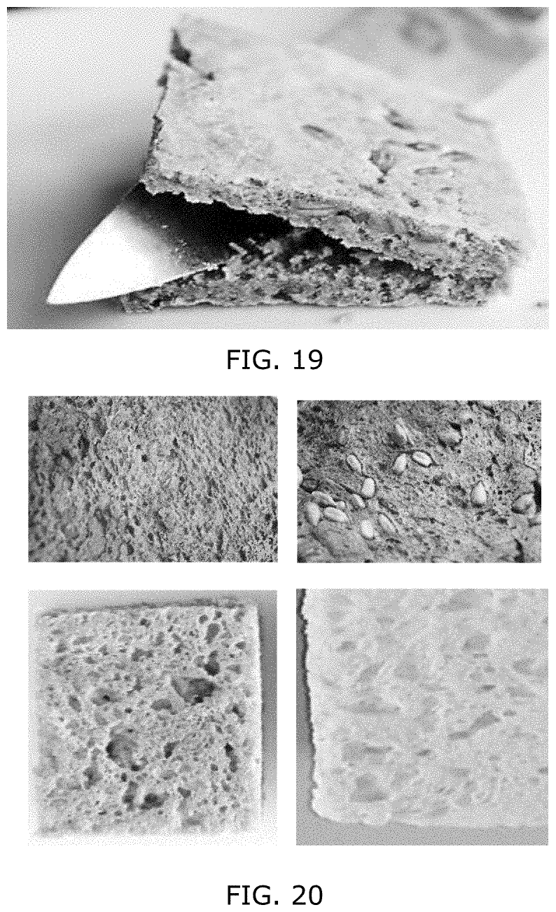

Pieces of super-thin bread 320 could have only one crust 335 (FIG. 3C). Such pieces of super-thin bread could be prepared by dividing along any direction a piece/s of super-thin bread that have two crusts along (FIG. 19). Usually, the two crusts are parallel to each other and formed by flat sides 905 and 910 (FIG. 9B) of mold 900. Alternatively, it is possible to divide the pieces of super-thin bread immediately after baking if the pieces of the super-thin bread were baked in a mode corresponding to the pita bread baking regime. The inner side of the divided piece of super-thin bread will maintain a soft spongy bread structure 340 (FIG. 3C).

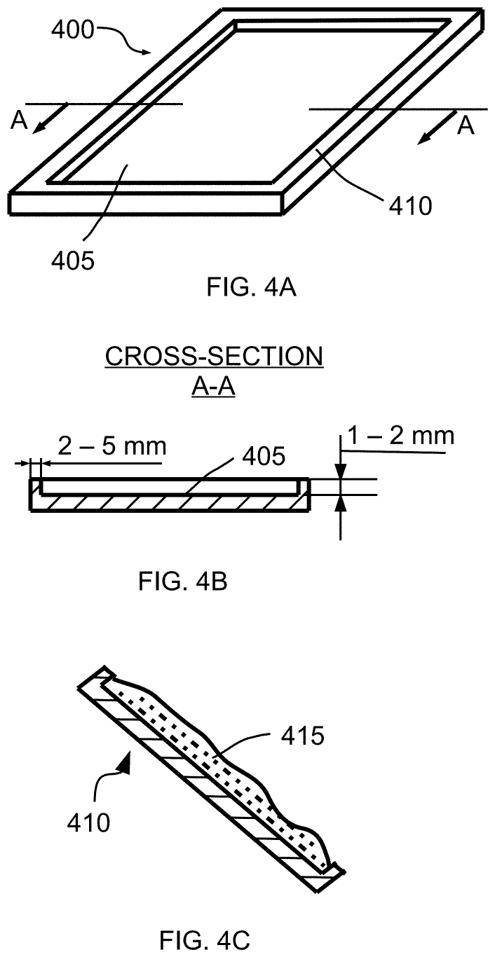

FIG. 4A is an example of a piece of super-thin bread with crusts on all sides. Super-thin bread 400, has a ledge preventing the filling from falling out of the piece of a super-thin bread. Super-thin bread 400 with a ledge 410 is convenient for preparation of sandwiches including sandwiches with a large amount of fillings or staffings 415 (FIG. 42C). Staffing 415 is placed on a surface 405 of a deep or pit formed by ledge 410. FIG. 4B shows a cross-section of super-thin bread 400. FIGS. 4 and 24 show a baked piece of bread with a ledge. FIG. 4C is a graphic version of a sandwich and FIG. 24 is a photographic picture illustrating a sandwich with a ledge filled by caviar and tilted at an angle of 60 degrees. Even with such large inclination, the filling stays in place, does not fall out, and does not stain clothes and fingers.

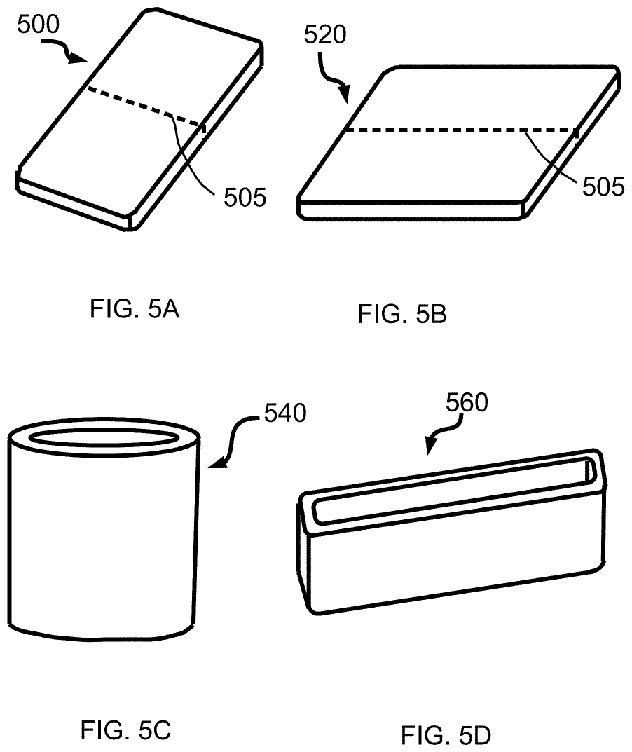

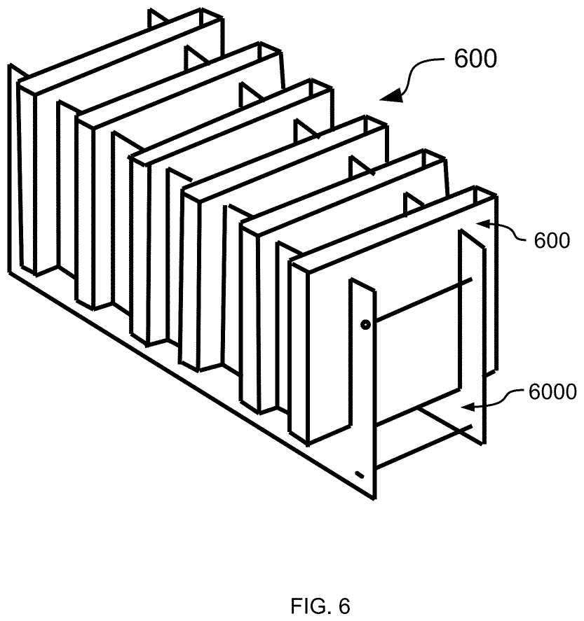

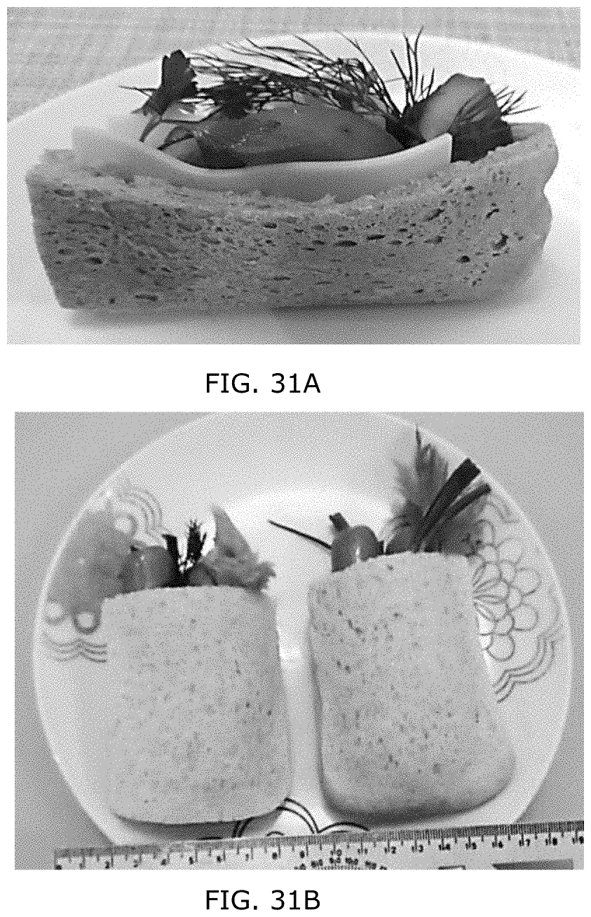

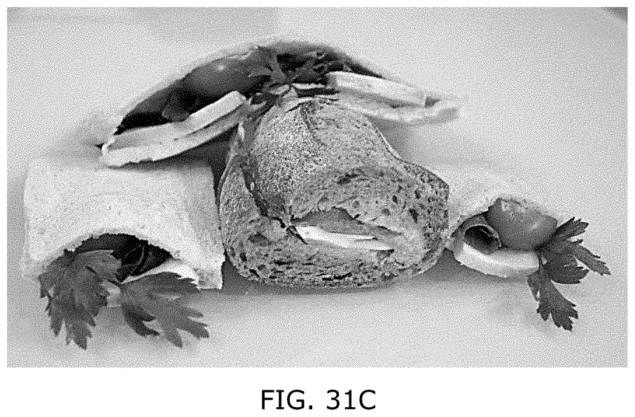

FIGS. 5A and 5B are examples of two baked super-thin bread slices of different sizes with crusts on all sides, and marked cut lines. Upon completion of baking each of super-thin bread 500, 520 is divided into two parts along line 505 and used as bread bags. The side of the cut along line 505 has no crust, and a knife could be used to form a pocket in any one of pieces of super-thin bread 500, 520. FIG. 5C and 5D are examples of bread pockets 540, 560 of different sizes, prepared from pieces of super-thin bread 500, 520 (FIG. 5A and 5B). Pockets 540, 560 could accept and store a variety of fillings (FIG. 31A, 31B). These super-thin bread bags have a soft spongy inside structure, are more convenient than existing sandwiches and as shown in FIG. 31C contain less bread. Super-thin bread pockets 540 and 560 can be baked with already divided interior space. Baking of pieces of super-thin bread with already divided interior space could be achieved by increase of baking temperature and shorter baking time, similar to pita bread baking mode.

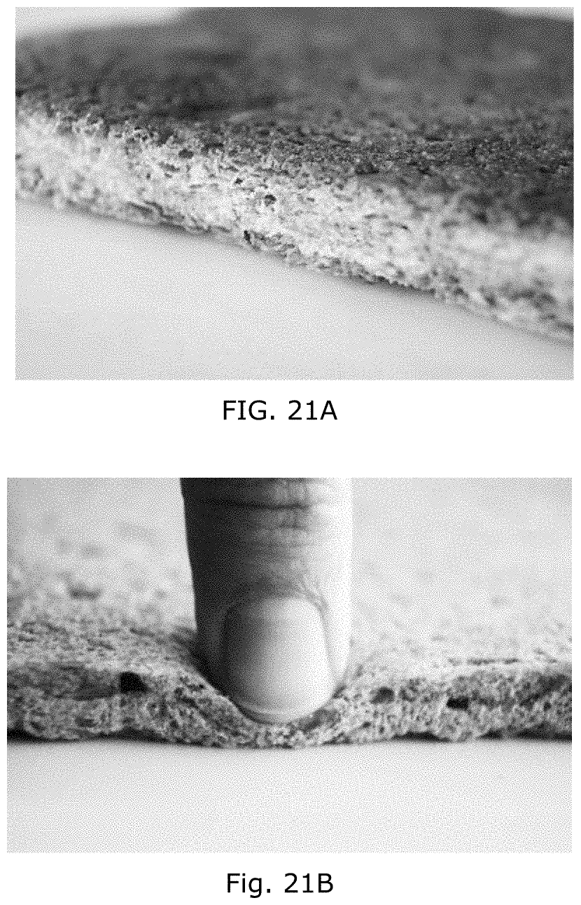

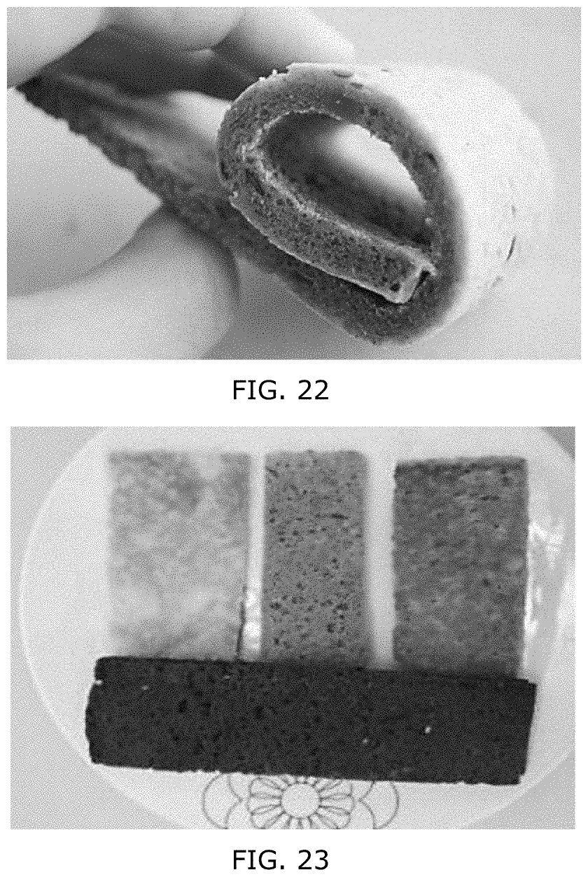

The texture of super-thin bread crusts can vary (FIG. 20). Depending on the baking regime, you can get a super-thin bread with thick, crispy crusts (FIG. 21A), with thin soft, almost imperceptible crusts (FIG. 21B), but always with a soft spongy structure. These slices of bread can be very flexible (FIG. 22); the slices can be bent, do not break and do not create crumbs. Children and cosmonauts can eat such bread. If you extend the baking time, you can get a cracker with a gentle crispy middle.

The pieces of super-thin bread are tastier and more fragrant than the pieces of bread cut from the loaf for the following reasons. Pieces of super-thin bread have two crusts. The crusts create a stronger taste and aroma.

The super-thin bread could include a variety of fresh herbs such as basil, coriander, parsley. Because of the short baking time, these herbs retain their taste and aroma in the bread. When baking ordinary bread, such herbs do not withstand long baking times and lose many of their properties. Short baking time allows an introduction into the super-thin bread ingredients that improve overall mood, sleep, weight loss. Also, short baking time saves fuel and energy.

Super-hin bread can be baked with different fillings. For example, with coffee, cannabis, and chocolate. The fillings, in addition to different taste, could provide the super-thin bread with different color and different texture. Fillings can be such as dried fruits, vegetables, nuts, as well as pieces of sausages, cheeses. The fillings could be sweet or salty.

Super thin bread can be baked entirely with vegetable ingredients—beans, lentils, chickpeas, and other legumes, or from various cereals. It can be baked rom alternative proteins, such as meat substitutes. The baking time of such bread does not depend on the weight and does not exceed 15 minutes.

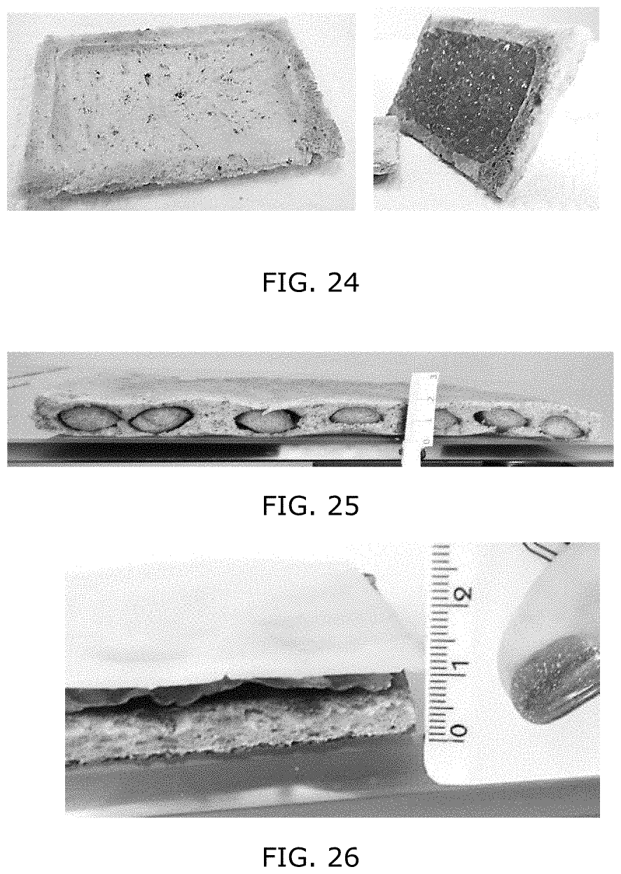

FIG. 25 is a cross-section of super-thin bread stuffed with pieces of sausages.

Super-hin bread, completely baked or prebaked, can be stored in the refrigerator, freezer, or vacuum package. To bake, super-thin bread can be immediately transferred to a hot oven or baking toaster. After a few minutes, the fresh bread with a crispy crust is ready. This is the fastest way to make freshly baked bread.

Super-hin bread could be baked in a matter of minutes from frozen dough placed in a disposable or permanent mold. The mold with the frozen dough could be transferred directly from the freezer to the baking device. Within a few minutes, the fresh bread will be ready for consumption. Such a quick warm-up and baking of super-thin bread is convenient, as it almost does not require time.

Thin sandwiches can be prepared from super-thin bread (FIGS. 26-29). They are attractive because they are convenient to hold and eat. Pieces of bread in such sandwiches do not crumble. They have fewer calories and contain a very small percentage of bread. Bread pockets or bags of super-thin bread (FIG. 31A, FIG. 31B), of different sizes with fillings are convenient to eat in any conditions. Super-hin bread and sandwiches prepared from the super-thin bread can be used for fast cooking at home, in the fast food system and as snacks.

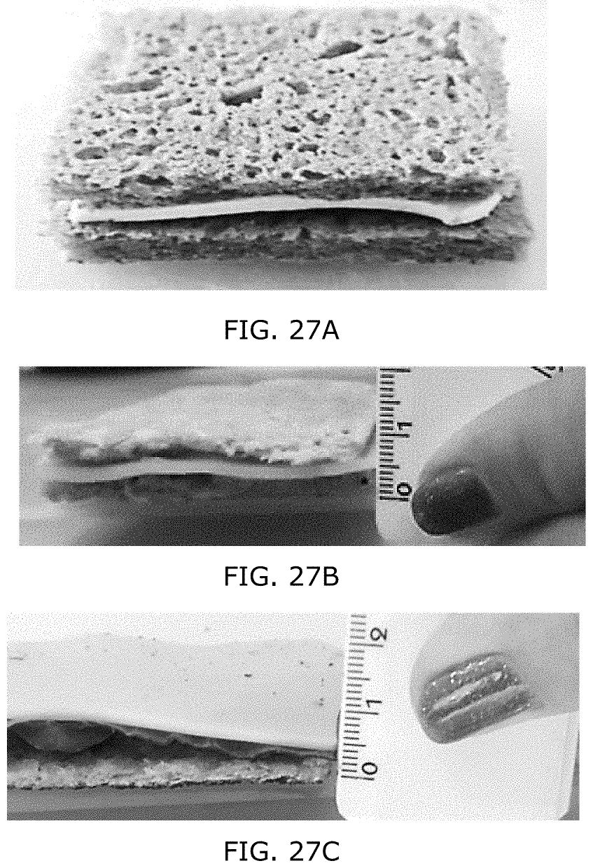

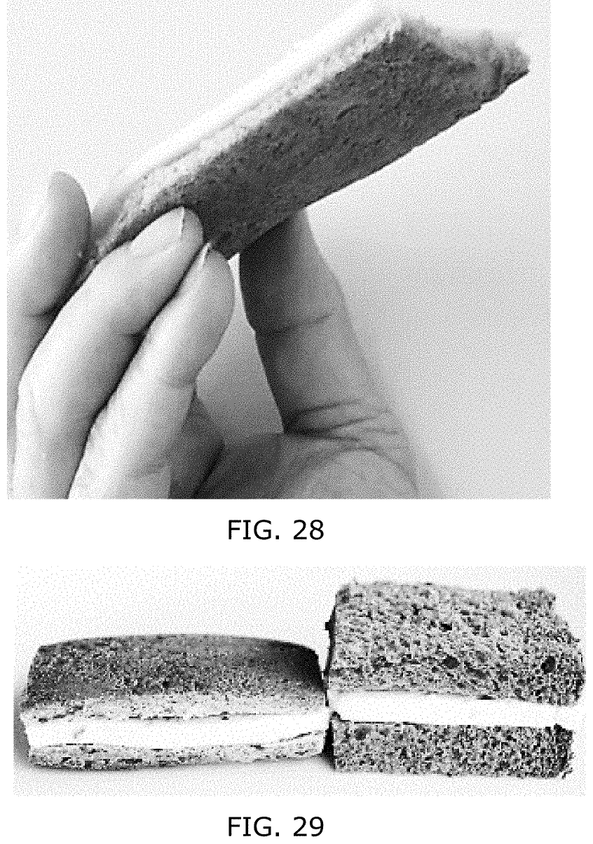

By using pieces of super-thin bread 320 divided along in two parts (FIG. 3C), sandwiches can be made even lighter. Such sandwiches (FIGS. 27A, 27B, 27C) have one crust and a thin layer of soft bread. The thickness of the super-thin bread sandwiches is 4-6 mm. As can be seen on (FIG. 28), such sandwiches are strong enough and do not bend.

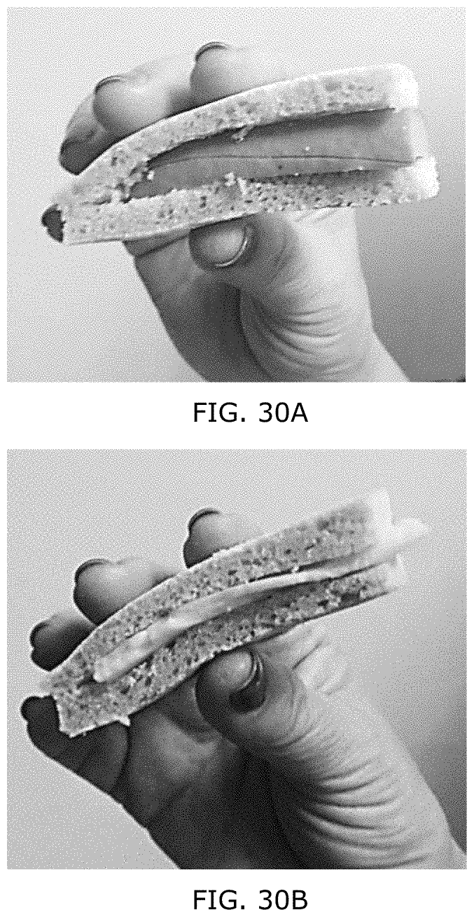

It is possible to divide the super-thin bread into pieces as shown on (FIGS. 30A and 30B). Each cut piece may not have a complete split into two parts. Such sandwiches are convenient to hold in one hand. The stuffing of the sandwich won't fall out.

FIG. 29 is a comparison of the amount of bread in a traditional sandwich and a super-thin bread sandwich. Both sandwiches contain the same amount of filling, which is cheese. A sandwich with slices of super-thin bread has a lower calorie content, as it contains a substantially less bread than a traditional sandwich contains. In a traditional sandwich it is impossible to reduce the amount of bread, as it is impossible to cut a loaf into two millimeter thin pieces. But even if it could be be possible to cut such thin pieces, they can not be held in hands. The cut pieces of traditional bread will sag, crumble, and will not hold the filling.

The filling can be put on thin slices of bread with two crusts (FIG. 26) and still get thin sandwiches.

Thin molded bread can be baked in different shape molds and in various appliances. For example: in ovens, industrial ovens, in bread baking toasters, and in pop-up toasters and conveyors. Currently, there are no breads that could be baked in a toaster. The thickness of the super-thin bread supports baking of super-thin bread in a toaster. The super-thin bread dimensions, provide an opportunity to develop baking bread toaster.

For baking in ovens and industrial ovens, baking molds 900 (FIG. 6) are applied vertically on a stand of 6000 in a 600 device.

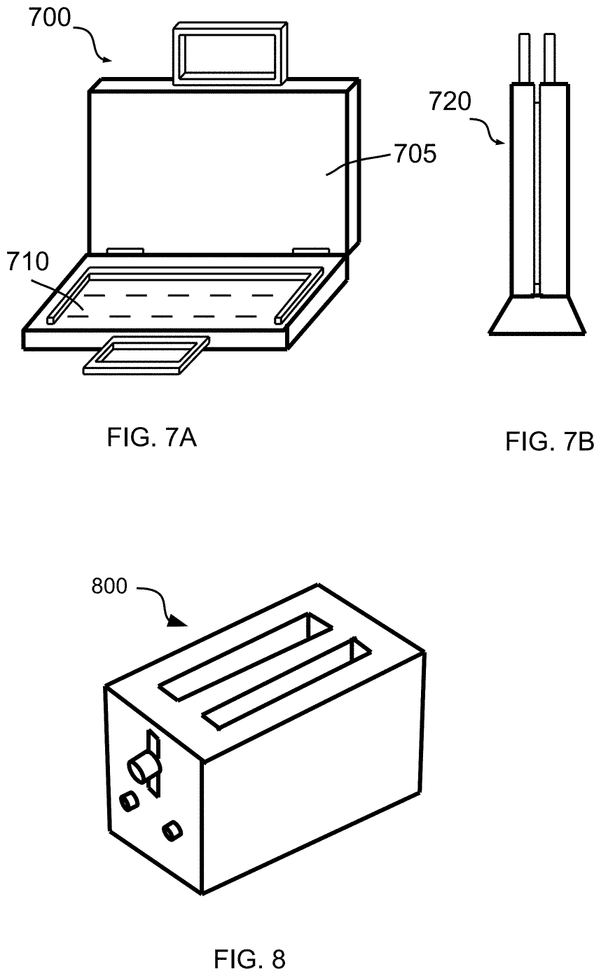

A two-part 705 and 570 (FIG. 7A) mold could be used for baking super-thin bread in baking toasters 700. The dough is laid out on the horizontal part of the form 710. Then baking toaster is closed and turned in an upright position 720 as shown in FIG. 7B. In this upright position of the toaster the dough is proofing and then bakes. In baking toaster it is possible to bake super-thin bread in disposable forms of aluminum foil.

It should be noted that baking super-thin bread in a mould in a horizontally oriented toaster causes steam to accumulate inside the bread and beneathe the upper shape. As a result, there could be formed large bubbles that spoil the texture of the crust. In the upright position of the toaster, the steam freely emerges from the mold. Because of this, the crusts have a homogeneous structure.

Baking toaster, in addition to baking bread molds, could include a programmable temperature control for proofing and baking super-thin bread. Additional devices that allow baking of the super-thin bread in upright orientation, and use of more powerful heating elements than those of existing toasters. The time of the proofing and dough growth could be determined for example, by laser sensors tracking the size of the dough rise. Other sensors, such as for example, mechanical sensors could also be used. As soon as the dough rises to the required height and blocks the laser beam, the laser sensor disables the temperature control of the toaster, and the baking begins at a higher temperature.

For proofing and baking in a pop-up toaster 800 (FIG. 8) baking molds 900 (FIG. 15) installed in a type of a cage 1500 to be inserted in a pop-up toaster. With a cage 1500 for a pop-up toaster, the molds are lowered vertically in the pop-up toaster. It is possible to bake, warm up as many pieces of super-thin bread as pop-up toaster accepts. Pop-up toaster, could have a programmable temperature control for proofing and baking, and a timer.

Molds 600 (FIG. 6) are suitable for proofing and baking super-thin bread in ovens, industrial ovens and other types of ovens. Molds 900 (FIGS. 9A and 9B), consist of two separate parts 905 and 910 placed at a distance opposite and parallel to each other. At least one edge of each of two separate parts 905 and 910 is bent in the direction of a placed opposite part to form a butt-end wall. The moulds are made of food grade aluminum or stainless steel. The inner surfaces of the form, which come into contact with the dough, are covered with non-stick coating.

The dough is restrained and baked in an upright position of the toaster. The top of the mold is fully or partially open. Dough 915 rises in the direction of the open side of the mold. In the process of proofing and baking, parts 905 and 910 of mold 900 are pressed against each other. The thickness of the bread baked depends on the size of the bent butt-end sides of the molds. The butt-end size or height defines thickness of the super-thin bread.

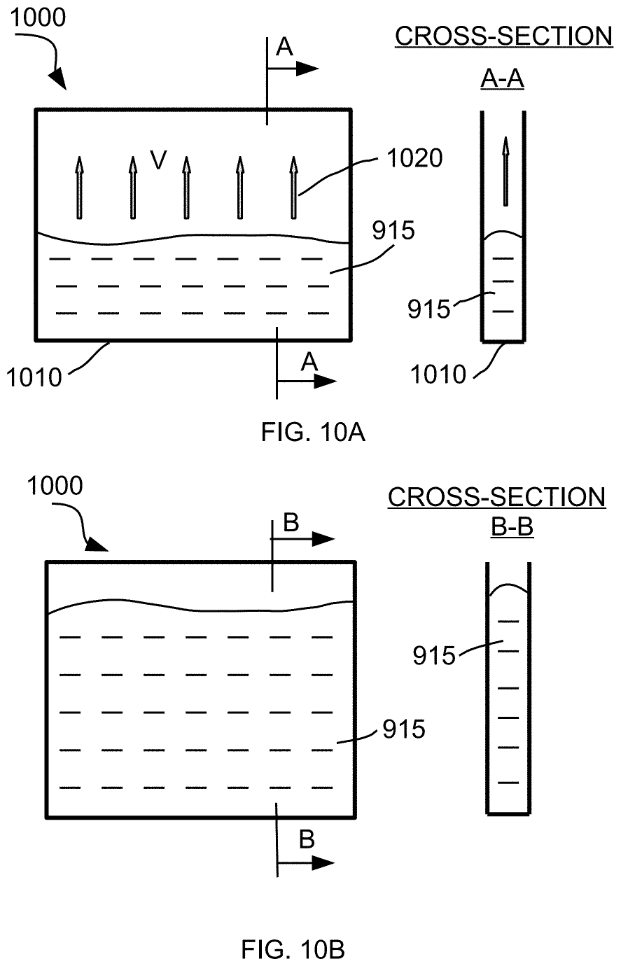

In existing molds 1000 (FIG. 10A), dough 915 for proofing and baking is laid on the bottom of a mold and fills the molds by about half. The dough, under the influence of gases produced by yeast, increases its volume and, overcoming gravity, rises at speed (V) 1020 and, after a while, fills the form (FIG. 10B).

If a conventional mold with the dough is turned open side to the ground, the portion of dough, which is in baking mold, falls out of the mold. The reason for this is the weight of the portion of the dough in the mold develops a force larger than the forces of attraction of the dough with the inner surfaces of the mold.

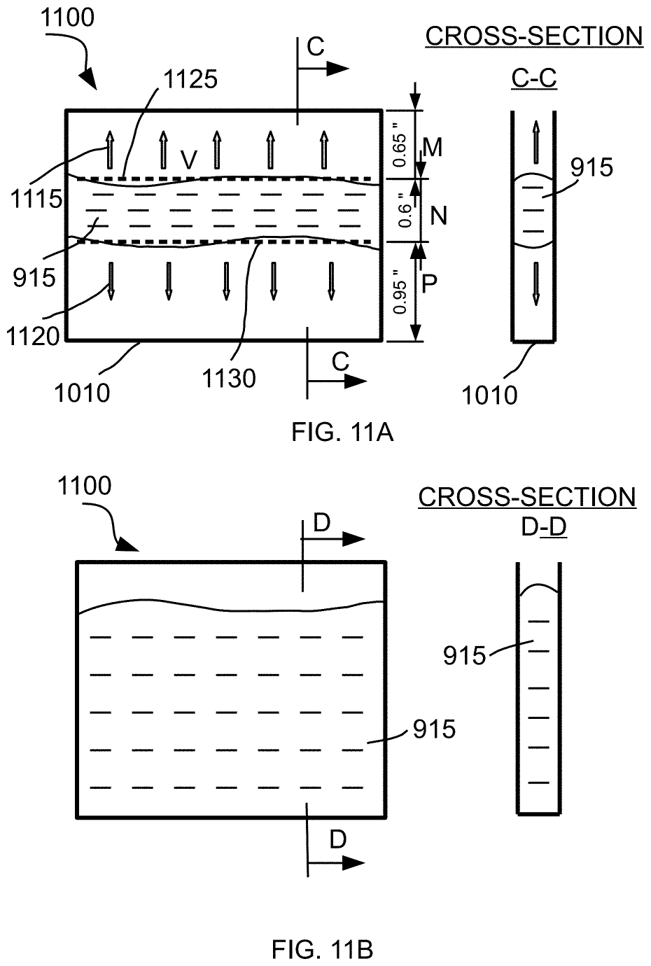

The same portion of dough placed in a super-thin bread baking mold 1100 (FIG. 11A) has a surface area that comes into contact with the interior surfaces of the mold much larger than in the existing form. Because of this the strength of adhesion of the portion of the dough with the inner walls of mold 1100 is greater than in the existing conventional molds. If the baking mold of super-thin bread is turned open side to the ground, the portion of dough, which is in the mold will remain stationary and will not fall out of the mold.

The immobility effect of the dough in the mold for baking super-thin bread accelerates the proofing of super-thin bread. The portion of dough 915 (FIG. 11A), which has a width of N, is placed in the horizontal position of a part of the mold and not at the bottom of the 1010 mold, but in the middle, closer to the top of the mould 1100. After the mold is closed and placed vertically, the batch of dough 915 is held in place by the walls of the mold, and does not fall down. In case of the super-thin bread dough 915 during the proofing increases its volume in two directions.

Direction 1. In the part M of mold 1100, the dough increased in volume and expanded to the top at a speed V speed, similar to expansion or growth in a conventional mold. In this direction, the dough overcame gravitational forces.

Direction 2. In part P of mold 1100, the dough increased in volume and expanded downwards at speed 1120 greater than the speed V of growth in the direction of 1115. In the middle section of a 12 mm mold, 300 grams of dough was laid out and the time was recorded complete filling of the form with dough in the vertical position of the form. The form was completed with a test in 36 minutes. The same weight of the dough was placed on the bottom of the mold. And under the same proofing conditions, the time of complete filling of the form was recorded. The form was completed with the test in 43 minutes. Gravitation assisted the expansion of the dough in the mold and allowed reducing the time of the proofing by about 20%. Thus, in process of the proofing of the dough for baking super-thin bread expanded not only up but also down and completely filled the mold (FIG. 11B).

For proofing and baking a portion of dough 1115 (FIG. 11A), is layed on the inside of one of the parts of the mold in a horizontal orientation. The place for laying a portion of the dough could be marked by two lines 1125 and 1130. The marking could be done on the inner surface of all or one of the parts of the molds on which the dough is placed.

The minimum distance from the bottom surface of the dough placed in the mold to the bottom of the mold is at least 30 mm.

If super-thin bread is baked in absence of gravitation force, for example, at space stations, a portion of dough should be placed strictly in the middle of the form, as there is no gravity in space. In this case, the test expansion will take place in opposite directions at the same speed.

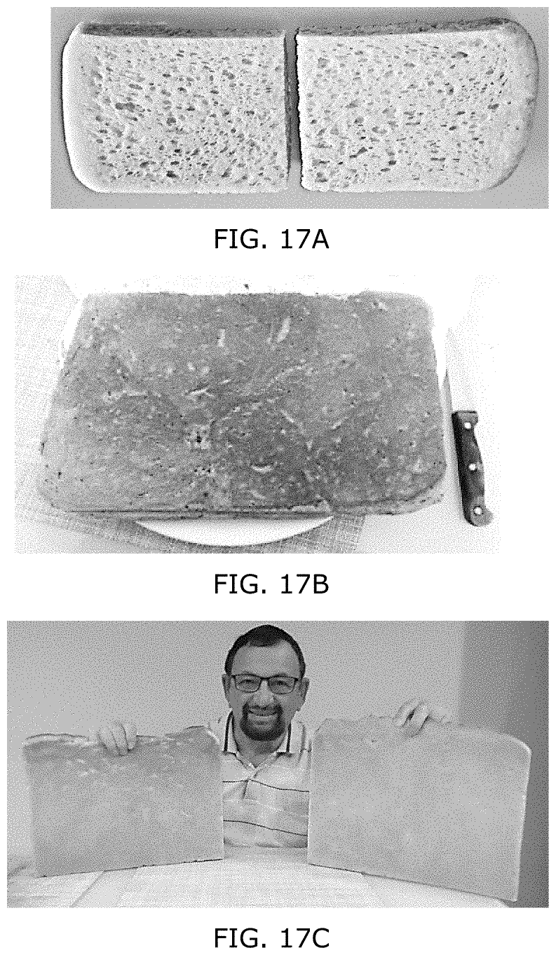

The size of baked super-thin bread (FIG. 17A), (FIG. 17B), (FIG. 17C) depends on the size of the molds. The typical size of a super-thin bread baking mold is 120 to 450 mm long; 50 to 350 mm wide and 3 to 50 mm high.

Mold designs could have their own features that depend on which appliance the super-thin bread will be baked. Different features could be implemented for baking in ovens, and industrial ovens, baking toasters, and pop-up toasters.

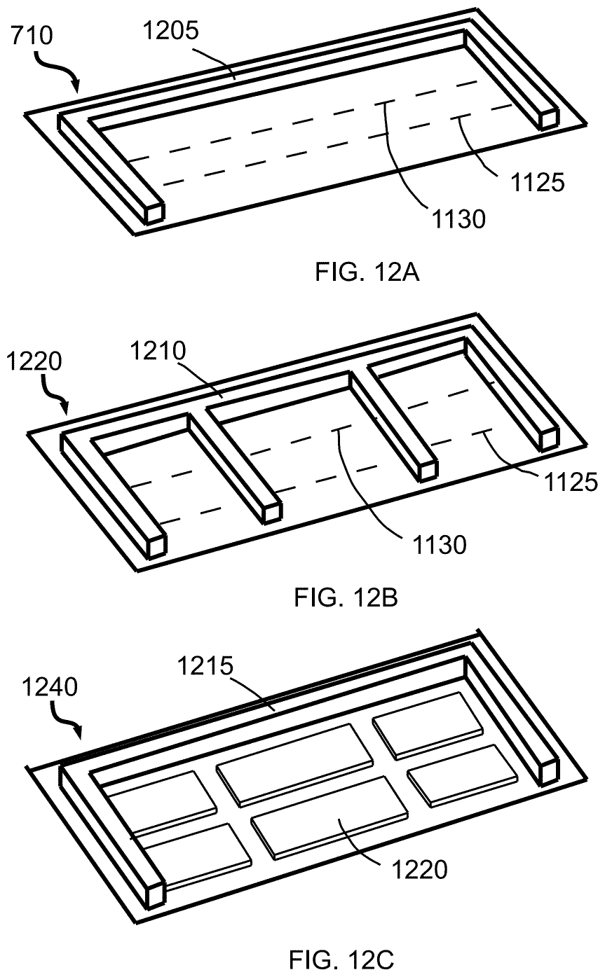

FIG. 12A is an example of a part of a mold for baking super-thin bread in baking toaster. The height of the frame 1205 determines the height of the baked piece of super-thin bread. For baking toasters (FIG. 7A), molds of different sizes could be made, and super-thin bread could be baked in them. As an example, the pieces of baked super-thin bread had the following dimensions: 290×180×6: 290×180×10; 290×180×15. Although larger pieces of super-thin bread could be baked and after cooling, the baked large pieces of super-thin bread could be cut into sizes acceptable for consumption.

FIG. 12B is an example of a part of a mold for baking ready to eat pieces of bread of various sizes. Ready for consumption pieces of different sizes of super-thin bread could be baked in a baking toaster. Pieces of super-thin bread (FIG. 17A) baked in this mold could also be used for preparation of bread pockets (FIG. 31).

The markings of 1125 and 1130 (FIG. 12A) and (FIG. 12B) on the lower parts of the mold show the place where the dough could be placed in the mold.

FIG. 12C is an example of a mold for baking slices of bread of different sizes. The lower part 1220 of mold 1240 supports baking of super-thin bread pieces in baking toaster. The pieces of super-thin bread could have a ledge (FIG. 4A) or be regular pieces of super-thin bread. The pieces of super-thin bread could be baked in a baking toaster (FIG. 4A), (FIG. 24). Protrusions 1220 form recesses 405 (FIG. 4A), in pieces of super-thin bread.

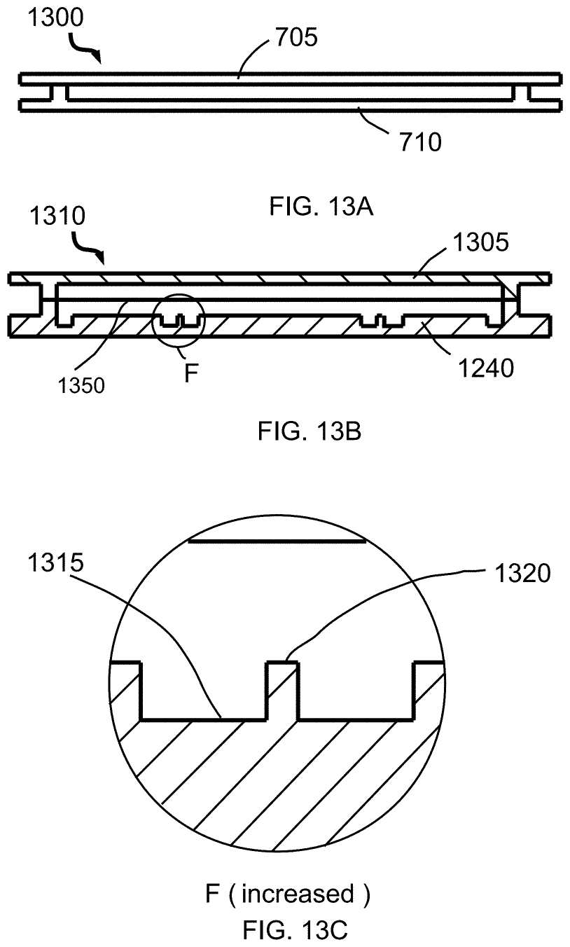

FIG. 13A is a schematic cross-section of a closed mold for use in baking toaster of FIG. 7A. Parts 705 and 710 of mold 1300 provide a closed mold for the proofing and baking of super-thin bread in baking toaster (top view). Alternatively, parts of 1305 and 1240 of a mold 1310 can bear some height elements of the ledge and have meeting plane 1350 in the middle. FIG. 13C shows protrusions 1320 made in surface 1315 of the mold. Protrusions, form a ledge in pieces of super-thin bread, as well as a thin ledge 1320, indicating a gap on the baked super-thin bread into which a knife could be inserted, and the piece of super-thin bread could be further cut into even thinner pieces and parts.

Molds filled with dough for baking super-thin bread can be disposable molds. Disposable molds filled with dough can be made of regular aluminium foil. The molds could be sold with a dough ready to proof, or with a dough ready for baking, with prebaked super-thin bread. Such filled forms can be sold both in vacuum packaging and in frozen form. It is enough to take this form with dough from the refrigerator or freezer, put in a heated baking tray or toaster, and after a few minutes without much difficulty to have fresh bread.

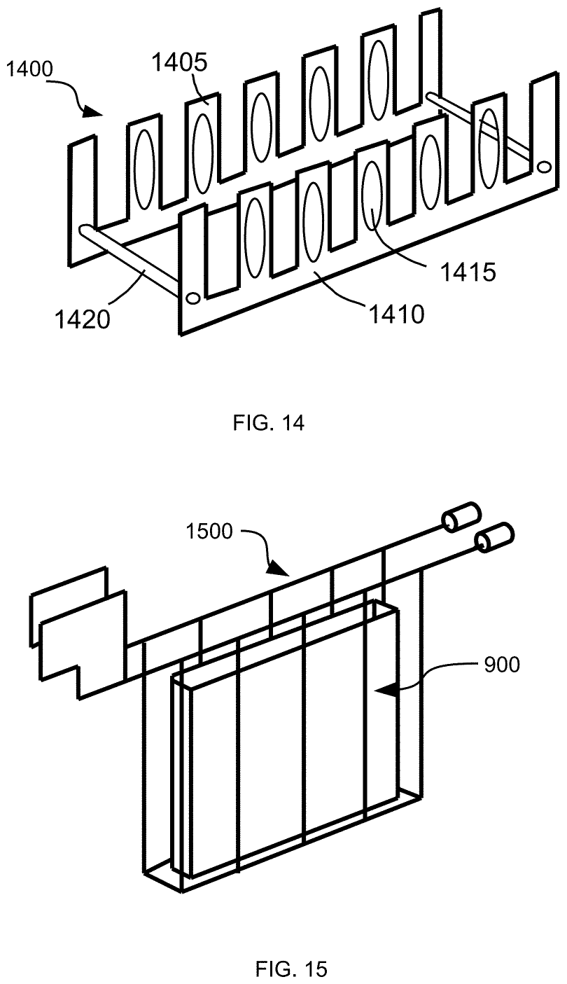

FIG. 14 is a three-dimensional illustration of a stand 1400 accepting molds 600 for proofing and baking super-thin bread simultaneously in several molds (FIG. 6). The stand consists of two identical plates 1405 and 1410 and two connecting parts 1420. The stand supports a vertical position or orientation for each mold, to ensure the two parts of each mold are closed and to provide the necessary circulation of hot air between the molds. Openings 1415 in plates 1405 and 1410 enhance hot air circulation.

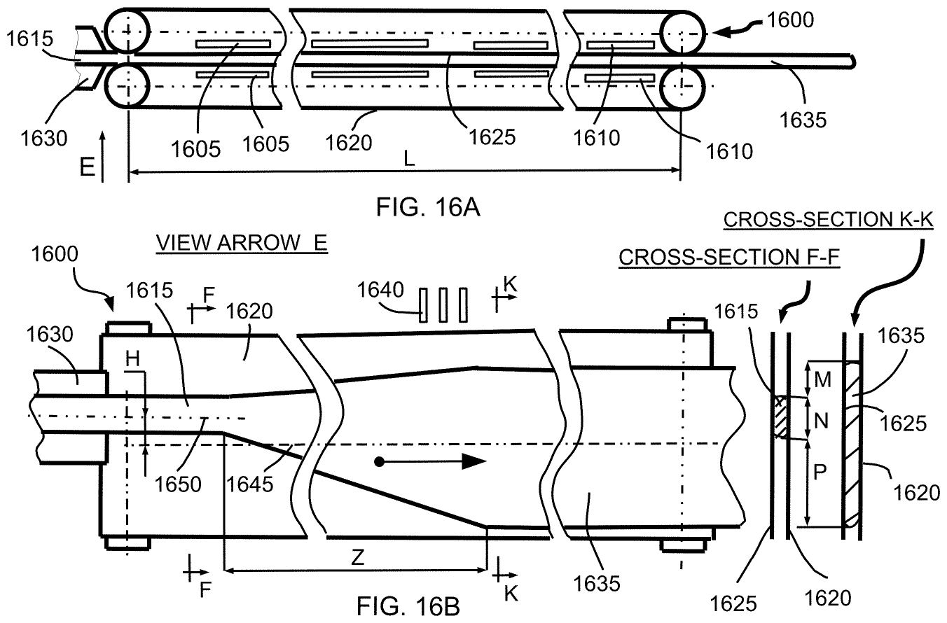

The process of proofing and baking super-thin bread is easily automated. Such automatic lines can provide continuous super-thin bread production. The production process is less labor-intensive than baking an existing form of bread and has a shorter period of production of super-thin bread. Automatic line for baking super-thin bread is cheaper than existing ones and more economical. On (FIG. 16A, B) schematically shown automatic line 1600 for baking super-thin bread.

The automatic line includes an extruder 1630, which continuously squeezes out a dough 1615. Extruder 1630 places the dough in a gap between two vertical continuously moving conveyor belts 1620 and 1625. The continuously moving ribbon of dough 1615 is formed by two vertically oriented, opposing each other conveyor belts 1620 and 1625, in which the dough proofing and baking take place. After proofing and baking, the super-thin bread 1635 is cut in pieces and packed into separate modules.

Conveyor belts can be of teflon® (tetrafluoroethylene), silicone or stainless steel. If teflon® or silicone conveyor belts are used, microwave heaters 1610 can be used to speed up baking separately or in combination with existing heaters (gas, electric, infrared lamps). If stainless steel conveyor belts are used, induction or conventional heaters can be used. The heaters heat the conveyor belts that transfer the heat to the dough.

The silicone or Teflon conveyor belts may have relief for baking super-thin bread with a relief. For example, the same relief as shown in FIG. 12C.

The length L of the automatic line (FIG. 16A) is determined by the required time of proofing and baking. The speed of conveyor belts, the temperature of the rack, and the baking temperature are subject to adjustment.

Conveyor 1600 works as follows. An N-wide dough ribbon 1615 is squeezed out of a dough extruder 1630. The thickness of dough extruded by extruder 1630 is slightly greater than the gap between conveyor belts 1620 and 1625. The axis of dough ribbon 1650 is located on a height H above the axis 1645 of conveyor belts 1620 and 1625. Ribbon of dough 1615, is continuously moving together with two of the conveyor belts where dough proofing takes place at the length Z. Heat sources 1605 heat the belts that transfer the heat to ribbon of dough 1615 to the temperature of the proofing, and increases in dough ribbon 1615 size. Part of dough ribbon 1615 rises to the magnitude M (FIG. 16B), part of the dough ribbon increases and falls on the value of P. Gravity helps the dough to fall down at a greater rate than raised. Dough 1615 fills the cavity between conveyor belts 1620 and 1625.

One or more sensors 1640 measure the height of the dough ribbon rise determine the end of the dough proofing. Baking of the dough takes place on the next section of the conveyor. The heaters 1610, placed along the conveyor belt, heat the dough through conveyor belts. Next, the finished super-thin bread 1635 moves to the cooling chamber, cut and packed.

Other Embodiments. The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

1. A method for baking a super-thin tin bread, the super-thin bread having a thickness of 5-50 mm, a length from 50 to 400 mm and a width from 50 to 400 mm, the method comprising:
proofing a dough in a baking mold having a thickness of 5-50 mm, a length from 50 to 400 mm and a width from 50 to 400 mm, in such a way that only one, narrow side of the dough in the baking mold faces air and the other five sides face a surface of the baking mold;
placing the baking mold with the dough into an oven in an upright position so that the narrow air-facing side of the dough is directed upwards;
baking the super-thin tin bread in the oven, wherein during baking an essentially identical crust is formed on all sides of the super-thin tin bread, except for the narrow air-facing side.

2. The method of claim 1, wherein the baking mold is a part of automatic baking lines.

3. The method of claim 1, wherein the super-thin tin bread is baked in the oven from the dough having a mass of 0.5 kg in less than 15 min.

4. The method of claim 1, wherein proofing the dough in the baking mold comprises placing the dough in a middle section of the baking mold such that during placement the dough is not in contact with a bottom side of the baking mold, which is a lowest side of the baking mold when the baking mold is placed into the oven in the upright position.

5. The method of claim 1, wherein during placement the dough is placed at a distance of least 30 mm from the bottom side of the baking mold.

6. The method of claim 1, wherein the baking mold has protrusions such that crust of wide sides of the super-thin bread has 1-2 mm depressions suitable for putting a filling inside the super-thin bread.

7. A super-thin tin bread obtained by the method of claim 1.

8. The super-thin tin bread of claim 7, wherein the super-thin bread has a thickness of 5-20 mm.

9. The super-thin tin bread of claim 7, having 1-2 mm depressions on crust of wide sides of the super-thin bread suitable for putting a filling inside the super-thin bread.

10. A super-thin tin bread having essentially a rectangular prism form with a thickness of 5-50 mm, a length from 50 to 400 mm and a width from 50 to 400 mm, wherein the super-thin tin bread has an essentially identical crust formed on five sides of the super-thin tin bread, and has a different crust formed on one of the narrow sides.

11. The super-thin tin bread of claim 10, wherein the super-thin bread has a thickness of 5-20 mm.
